(19) United States
(12) Patent Application Publication
(10) Pub. No.: US 2023/0311162 A1
(43) Pub. Date: Oct. 5, 2023

(54) AGRICULTURAL MATERIAL SORTING APPARATUS

(71) Applicant: TRIMWORKZ, LLC, Gold Hill, OR (US)

(72) Inventor: Jeffery M. Laeger, Gold Hill, OR (US)

(21) Appl. No.: 17/712,737

(22) Filed: Apr. 4, 2022

(51) Int. Cl. B07B 1/22; B07B 1/08; B07B 1/42; B07B 13/16

(52) U.S. Cl. CPC B07B 1/22; B07B 1/08; B07B 1/42; B07B 13/16; B07B 2220/00

(57) ABSTRACT

A sorting apparatus is provided for sorting agricultural product by size and shape using a trommel. Agricultural product is received in a hopper and exits the hopper via an aperture onto a platform. A ram cyclically moves across the platform to transfer product from the hopper into the trommel.

### TECHNICAL FIELD

The present disclosure relates generally to equipment utilized to sort agricultural products and more particularly to sorting agricultural materials using a trommel and a ram.

### BACKGROUND

When processing agricultural products, it is often necessary to sort material by size and/or shape. Typically, this sorting is performed using a roller bed having filters increasing in size and a conveyor belt for moving material which falls through the roller bed filters. These sorting systems are often large, having multiple moving parts which make the devices more expensive and more prone to failure.

### SUMMARY

The present disclosure provides a sorting apparatus including a hopper, a rotating trommel for sorting agricultural product, and a ram for pushing product from the hopper onto the trommel.

According to one aspect of the disclosure, there is provided an apparatus for sorting material using a trommel configured to screen the material based on size and shape. The apparatus includes a hopper and a ram. The hopper has a repository configured to receive and store the material, an aperture comprising an opening in the repository and providing an exit from the repository for the material stored in the repository, and a platform configured to receive the material exiting the repository through the aperture. The ram is configured to cyclically move across the platform from a home position to a pushing position. In the home position, the ram is positioned to allow the material to exit the repository through the aperture and to be received by the platform. During movement of the ram from the home position to the pushing position, the ram transfers the material from the platform into the rotating trommel.

Alternatively or additionally, the apparatus includes an actuator configured to drive the ram cyclically from the home position to the pushing position.

Alternatively or additionally, the actuator is further configured to rotate the trommel.

Alternatively or additionally, the hopper further includes a door configured to cyclically move from an open position to a closed position. In the closed position, the door retards the material on the platform from entering the trommel. In the open position, the door allows the material on the platform to enter the trommel.

Alternatively or additionally, the ram is mechanically linked to the door, such that movement of the door from the closed position to the open position transitions the ram from the home position to the pushing position.

Alternatively or additionally, the ram is mechanically linked to the door via a bell crank.

Alternatively or additionally, the actuator is further configured to cyclically move the door from the open position to the closed position.

Alternatively or additionally, the hopper includes a cam mechanically linked to the trommel, such that rotation of the trommel rotates the cam. The cam has an eccentric perimeter with a base radius and a prime radius that is larger than the base radius. The cam is configured to engage with the door, such that: the door is in the closed position when the perimeter of the cam with the base radius engages with the door; and the door is in the open position when the perimeter of the cam with the prime radius engages with the door.

Alternatively or additionally, the apparatus also includes the trommel and a trommel actuator configured to rotate the trommel. The trommel actuator is separate and distinct from the actuator configured to drive the ram.

According to another aspect of the disclosure, there is provided a method for sorting agricultural material stored in a hopper using a ram and a trommel. The method includes placing the agricultural product in the hopper, such that the agricultural product is stored in a repository of the hopper. The method also includes positioning the ram in a home position, such that a portion of the agricultural product exits the repository by passing through an aperture of the hopper onto a platform of the hopper. The method further includes moving the ram from the home position to a pushing position, such that the ram transfers the material from the platform into the trommel. The method additionally includes cyclically driving the ram across the platform from the home position to the pushing position, such that the agricultural product passes through the aperture of the hopper onto the platform and is transferred from the platform to the trommel.

Alternatively or additionally, the cyclical driving of the ram across the platform is performed using an actuator.

Alternatively or additionally, the method further includes rotating the trommel using the actuator to screen the agricultural material based on size and shape.

Alternatively or additionally, the method further includes cyclically moving a door of the hopper from an open position to a closed position. In the closed position, the door retards the material on the platform from entering the trommel. In the open position, the door allows the material on the platform to enter the trommel.

Alternatively or additionally, the cyclical movement of the door from the open position to the closed position is performed using the actuator.

Alternatively or additionally, the method further includes rotating the trommel using a trommel actuator that is separate and distinct from the actuator used to drive the ram.

Alternatively or additionally, the agricultural material is from a cannabaceae plant.

According to a further aspect of the disclosure, there is provided an apparatus for sorting material from cannabaceae plants. The apparatus includes a hopper, a trommel, and a ram. The hopper has a repository configured to receive and store the material, an aperture comprising an opening in the repository and providing an exit from the repository for the material stored in the repository, and a platform configured to receive the material exiting the repository through the aperture. The trommel configured to receive the material from the hopper and screen the material based on size and shape. The ram is configured to cyclically move across the platform from a home position to a pushing position. In the home position, the ram is positioned to allow the material to exit the repository through the aperture and to be received by the platform. During movement of the ram from the home position to the pushing position, the ram transfers the material from the platform into the trommel.

Alternatively or additionally, the apparatus further includes an actuator configured both to drive the ram cyclically from the home position to the pushing position and to rotate the trommel.

Alternatively or additionally, the hopper further includes a door configured to cyclically move from an open position to a closed position. In the closed position, the door retards the material on the platform from entering the trommel. In the open position, the door allows the material on the platform to enter the trommel. The ram is mechanically linked to the door, such that movement of the door from the closed position to the open position transitions the ram from the home position to the pushing position.

Alternatively or additionally, the hopper includes a cam mechanically linked to the trommel, such that rotation of the trommel rotates the cam. The cam has an eccentric perimeter with a base radius and a prime radius that is larger than the base radius; the cam is configured to engage with the door, such that: the door is in the closed position when the perimeter of the cam with the base radius engages with the door; and the door is in the open position when the perimeter of the cam with the prime radius engages with the door.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages, and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a side perspective view of an embodiment of a sorting apparatus including a trommel.

FIG. 2 is a side view of the sorting apparatus of FIG. 1 showing a ram of the sorting apparatus in a pushing position.

FIG. 3 is a side view of the sorting apparatus of FIG. 2 showing the ram of the sorting apparatus in a home position.

FIG. 4 is a side view of the sorting apparatus of FIG. 1 showing the ram of the sorting apparatus pushing material into the trommel.

FIG. 5 is a front perspective view of an embodiment of the sorting apparatus including a cam and a door in the closed position.

FIG. 6 is a front view of the sorting apparatus of FIG. 5.

FIG. 7 is a front perspective view of the sorting apparatus of FIG. 5 without the cam.

FIG. 8 is a front perspective view of the sorting apparatus of FIG. 5 with the door in the closed position.

FIG. 9 is a front view of the sorting apparatus of FIG. 8.

FIG. 10 is a front perspective view of the sorting apparatus of FIG. 8 without the cam.

FIG. 11 is a flow diagram depicting a method for sorting agricultural material stored in a hopper using a ram and a trommel.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

According to a general embodiment, a sorting apparatus is provided for sorting agricultural product by size and/or shape using a trommel. Agricultural product is received in a hopper and exits the hopper via an aperture onto a platform. A ram cyclically moves across the platform to transfer product from the hopper into the trommel.

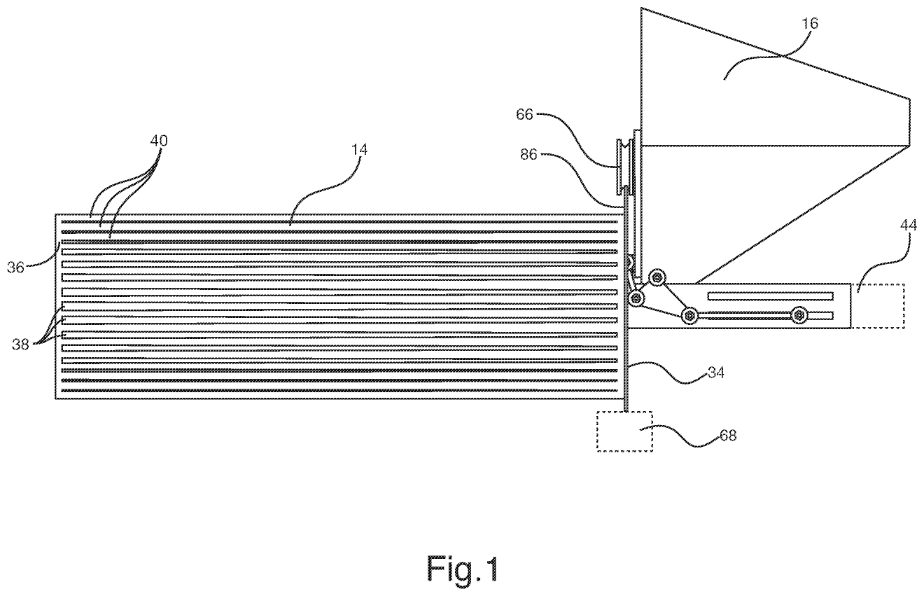

Turning to FIGS. 1, 2, 3, and 4, an apparatus 10 (also referred to as a sorting apparatus) for sorting material 12 using a trommel 14 is shown. The apparatus 10 includes a hopper 16 and a ram 18. The hopper 16 has a repository 20, an aperture 22, and a platform 24. The repository 20 is configured to receive and store the material 12. The material 12 stored in the repository 20 exits the repository 20 onto the platform 24 via the aperture 22. The ram 18 cyclically moves across the platform 24 from a home position 30 to a pushing position 32. In the home position 30, the ram 18 is positioned to allow the material 12 to exit the repository 20 through the aperture 22 and to be received on the platform 24. During movement of the ram 18 from the home position 30 to the pushing position 32, the ram 18 transfers the material 12 from the platform 24 into the trommel 14.

The hopper 16 may be any suitable structure sized and shaped for to hold and direct the material 12 (e.g., via gravity) towards the aperture 22. The hopper 16 may be made of any suitable material (e.g., metal such as steel or aluminum).

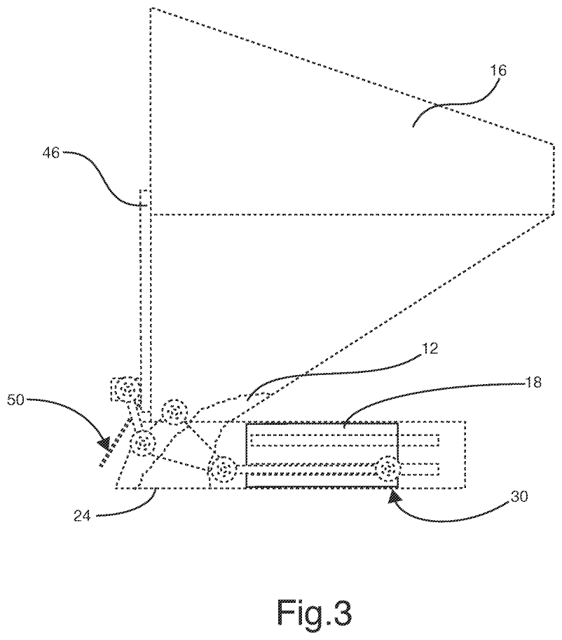

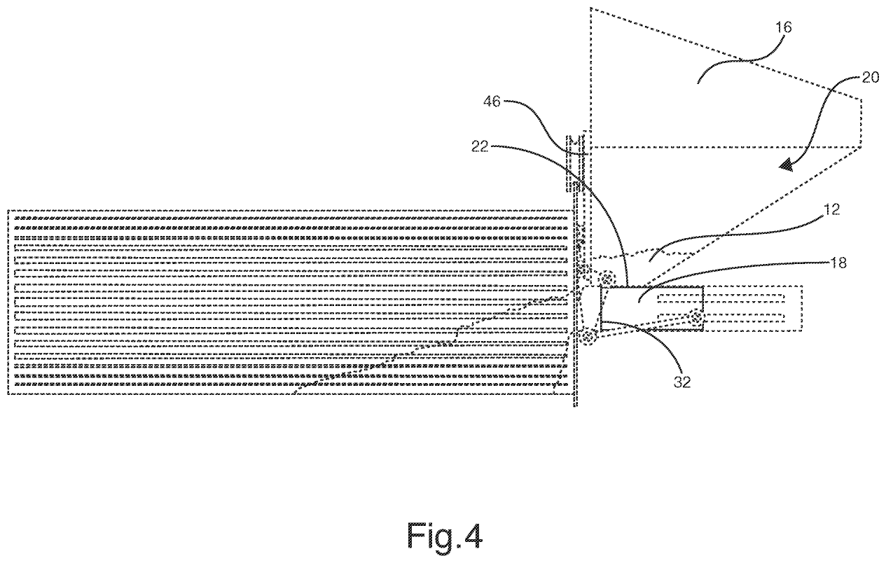

As shown in FIGS. 3 and 4, the aperture 22 is an opening in the repository 20 and provides an exit from the repository 20 for the material 12 stored in the repository 20. The platform 24 is positioned to receive and support the material 12 exiting the repository 20 through the aperture 22. The material 12 that is supported by the platform 24 is then pushed from the platform 24 and into the trommel 14 when the ram 18 moves from the home position 30 to the pushing position 32.

The aperture 22 may be any suitable passageway for the material 12 to exit the repository 20. For example, the aperture 22 may be an opening at or near a bottom of the repository 20 that is large enough for the material 12 to pass through.

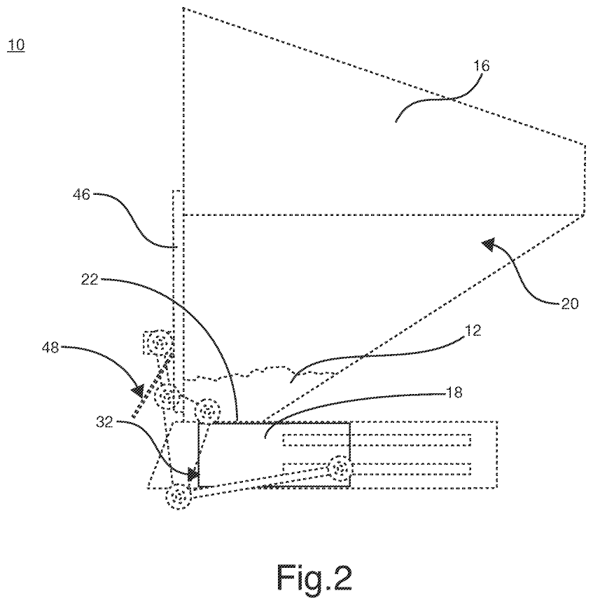

In the embodiment shown in FIG. 2, the ram 18 at least partially blocks the aperture 22 when the ram 18 is located in the pushing position 32. For example, material 12 may exit the repository 20 via the aperture 22 more slowly when the ram 18 is located in the pushing position 32 than when the ram 18 is located in the home position 30. As an example, the ram 18 may block at least 50%, at least 75%, or at least 90% of the aperture 22 when the ram 18 is located in the home position 30.

The ram 18 may be any suitable structure for moving the material 18 from the platform 24. For example, the ram 18 may have a flat or angled surface for pushing against the material 12. In one embodiment, the ram 18 is a rectangular block.

The platform 24 may be any suitable surface for receiving and supporting the material 12. For example, the platform 24 may be a flat surface that the ram 18 slides over, such that the material 12 is pushed by the ram 18 from the platform 24.

As described above, the trommel 14 is positioned to receive the material 12 from the platform 24 of the hopper 16. The trommel 14 screens the received material 12 based on size and/or shape. For example, the trommel 14 may rotate to move material 12 from an entrance 34 of the trommel 14 towards an exit 36 of the trommel 14. The trommel 14 may include openings 38 that increase in size with distance from the entrance 24, such that smaller shaped material 12 falls through the trommel 14 closer to the entrance 34 and larger shaped material 12 falls through the trommel 14 further from the entrance 34. In one example, the openings 38 may be formed in a cylindrical screen. In another example, the trommel 14 includes blades 40 forming a cylindrical shape. The spacing between the blades 40 may increase with distance from the entrance 24 (e.g., by the width of at least some of the blades 40 decreasing with distance from the entrance 24) allowing larger material 12 to pass between the blades further from the entrance 24.

The apparatus 10 may also include receptacles (not shown) positioned relative to the trommel 14, such that material 12 passing through the opening in the trommel 14 is received by one of the receptacles. Because the size and/or shape of the material 12 passing through the trommel 14 may be dependent upon a location along the trommel 14 (i.e., a distance from the entrance 34 of the trommel 14), the properties of the material 12 received by each receptacle may depending on the location of the receptacle relative to the trommel 14. For example, the receptacles may be walled bins having an at least partially open top. Multiple bins may be placed underneath the trommel 14, such that material 12 falling through the trommel 14 is caught by a different receptacle depending on the location on the trommel 14 that the material 12 fell through. In this way, the receptacles may be positioned to receive material of different sizes and/or shapes.

The apparatus 10 may also include an actuator 44 configured to drive the ram 18 cyclically from the home position 30 to the pushing position 32. The actuator 18 may be any suitable device for cyclically driving the ram 18 between the home position 30 and the pushing position 32. For example, the actuator 44 may be an electric or pneumatic motor, a linear screw, etc. In one embodiment, the actuator 44 may also rotate the trommel 14.

In one embodiment, the hopper 16 includes a door 46 configured to cyclically move from an open position 48 to a closed position 50. In the closed position 50, the door 46 retards the material 12 on the platform from entering the trommel 14. In the open position 48, the door 46 allows the material 12 on the platform to enter the trommel 14. For example, the door 46 may block at least 25%, at least 50%, at least 75%, or at least 90% of an opening between the platform 24 and the trommel 14. In the embodiment shown in FIG. 2, a portion of the door 46 is angled away from being perpendicular to the platform 24, such that some of the material 12 may pass from the platform 24 into the trommel 14 when the ram 18 is positioned in the home position 30. That is, in the closed position 50, the door 46 permits material 12 to move into the trommel 14.

In one embodiment, the ram 18 may be mechanically linked to the door 46, such that movement of the door 46 from the closed position 50 to the open position 48 transitions the ram 18 from the home position 30 to the pushing position 32. For example, the ram 18 may be mechanically linked to the door 46 via a bell crank 54 as shown in FIGS. 2 and 3.

In one embodiment, the actuator 44 is further configured to cyclically move the door 46 from the open position 48 to the closed position 50. For example, the hopper 16 may include a cam 56 mechanically linked to the trommel 14, such that rotation of the trommel 14 rotates the cam 56 as shown in FIG. 4. The cam 56 may have an eccentric perimeter 58 with a base radius 60 and a prime radius 62 that is larger than the base radius 60. The cam 56 may be configured to engage with the door 46, such that (1) the door 46 is in the closed position 50 when the perimeter 58 of the cam 56 with the base radius 60 engages with the door 46; and (2) the door 46 is in the open position 48 when the perimeter 58 of the cam 56 with the prime radius 62 engages with the door 46.

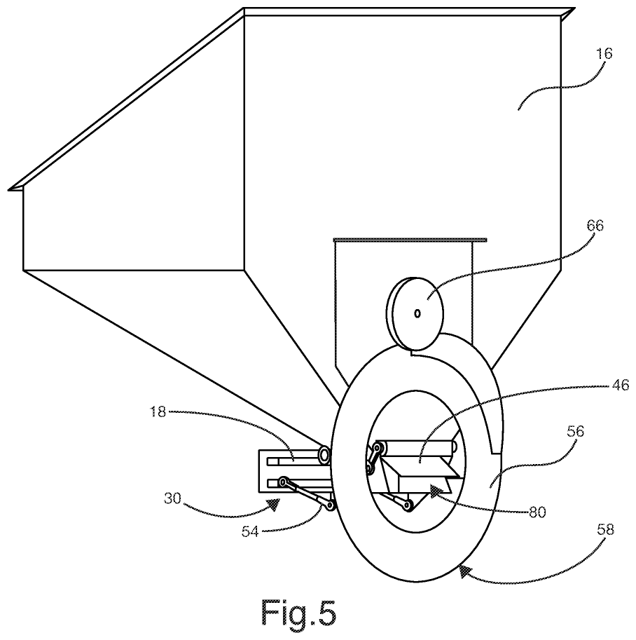

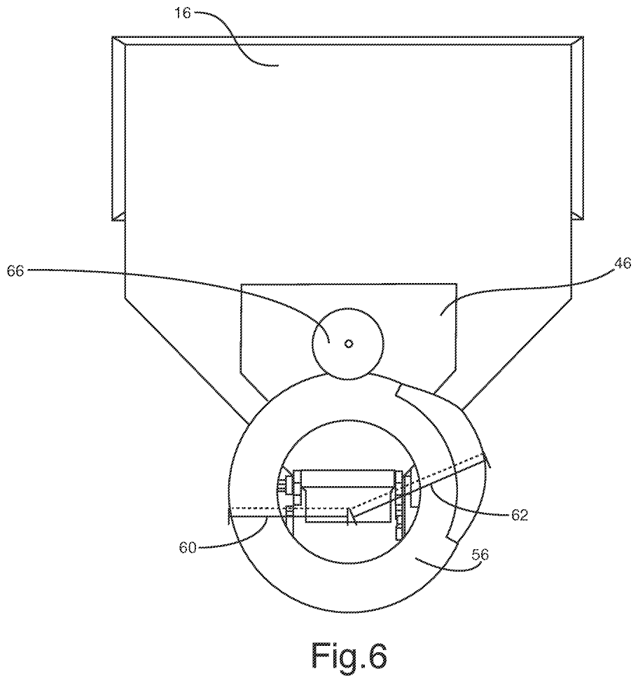

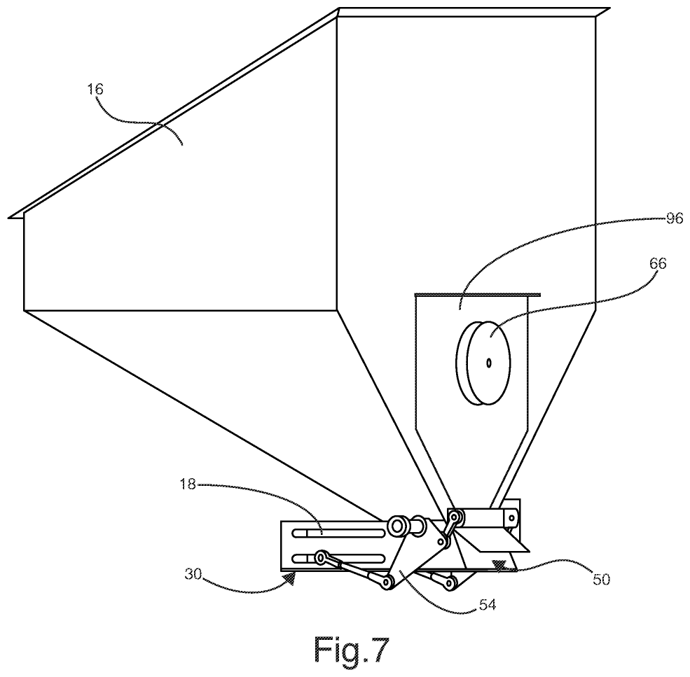

For example, in the embodiments shown in FIGS. 5-7, the door 46 is in the closed position 50 with the perimeter 58 of the cam 56 with the base radius 60 engaging with the door 46 via a wheel 66. The wheel 66 may be fixed to the door 46, such that non-rotational movement of the wheel 66 results in a corresponding movement of the door 46. In this embodiment, the wheel 66 is permitted to move vertically.

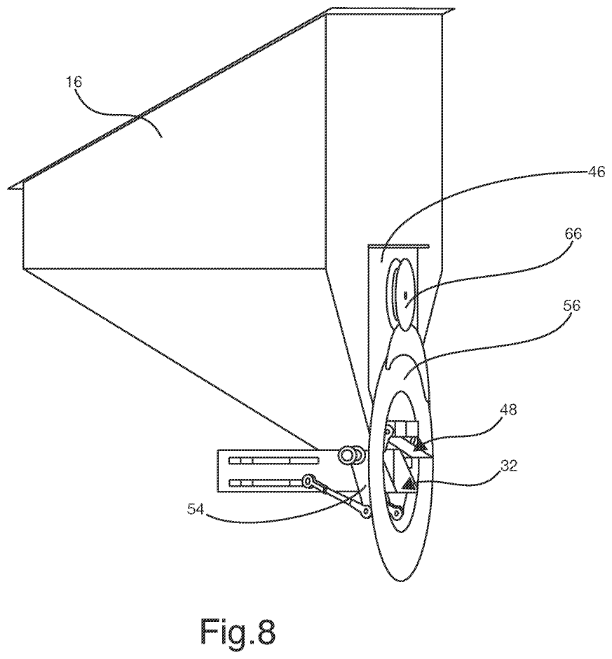

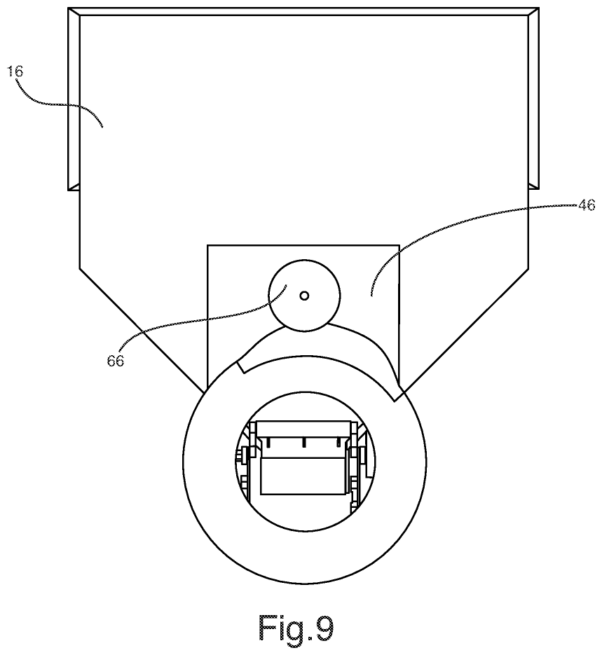

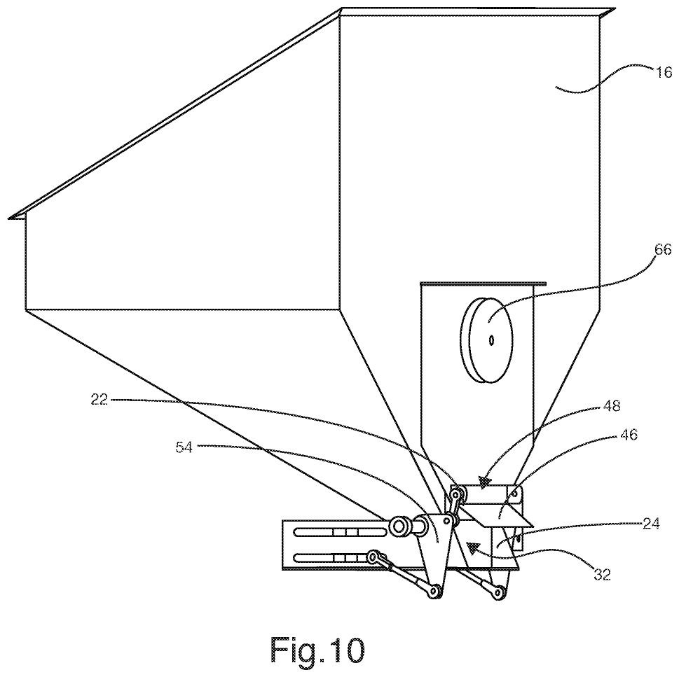

In the embodiments shown in FIGS. 8-10, the cam 56 has rotated, such that the perimeter 58 of the cam 56 with the prime radius 62 is engaging with the door 46 via the wheel 66. Because the prime radius 62 is larger than the base radius 60 and because the wheel 66 is permitted to move vertically, the wheel 66 has been moved vertically by the cam 56. Because the vertical position of the wheel 66 in this embodiment is fixed relative to the door 46, the vertical movement of the wheel 66 causes a corresponding vertical movement of the door 46 to the open position 48.

As shown in FIG. 1, the apparatus 10 may include a trommel actuator 68 configured to rotate the trommel 14. The trommel actuator 68 may be separate and distinct from (i.e., a different actuator than) the actuator 44 configured to drive the ram 18.

The apparatus 10 may be used for sorting any type of material 12. In one embodiment, the material 12 comprises an agricultural material 12. For example, the agricultural material 12 may be a component of a plant. As an example, the material 12 may include portions of cannabaceae plants, such as buds from a Cannabis sativa plant (e.g., marijuana).

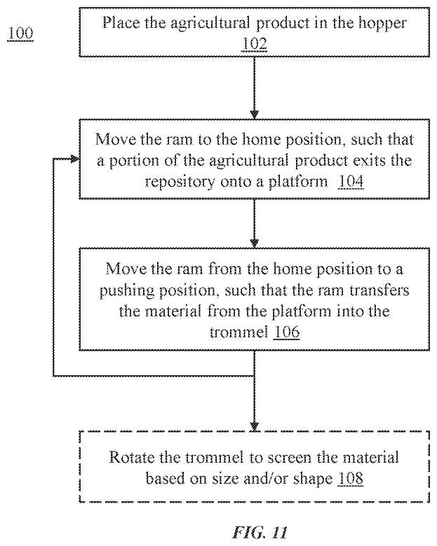

Turning to FIG. 11, an embodiment of a method 100 is shown for sorting agricultural material 12 stored in a hopper 16 using a ram 18 and a trommel 14. In step 102, the agricultural product 12 is placed into the hopper 16, such that the agricultural product 12 is stored in a repository 20 of the hopper 16. In step 104, the ram 18 is positioned in the home position 30, such that a portion of the agricultural product 12 exits the repository 20 by passing through the aperture 22 of the hopper 16 onto the platform 24 of the hopper 16. In step 106, the ram 18 is moved from the home position 30 to the pushing position 32, such that the ram 18 transfers the material 12 from the platform 24 into the rotating trommel 14. Steps 104 and 106 are then repeated to cyclically drive the ram 18 across the platform 24 from the home position 30 to the pushing position 32, such that the agricultural product 12 passes through the aperture 22 of the hopper 16 onto the platform 24 and is transferred from the platform 24 to the trommel 14. In optional step 106, the trommel is rotated (e.g., using the actuator 44) to screen the agricultural material 12 based on size and/or shape.

The cyclical driving of the ram 18 across the platform 24 may be performed using an actuator 44, by hand (e.g., turning a crank by hand), or using any suitable method for driving the ram 18. For example, the actuator 44 may be an electric, hydraulic, pneumatic, thermal, magnetic, or mechanical actuator, such as a linear or rotary actuator.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An apparatus for sorting material using a trommel configured to screen the material based on size and shape, the apparatus comprising:
a hopper having a repository configured to receive and store the material, an aperture comprising an opening in the repository and providing an exit from the repository for the material stored in the repository, and a platform configured to receive the material exiting the repository through the aperture; and
a ram configured to cyclically move across the platform from a home position to a pushing position, wherein:
in the home position, the ram is positioned to allow the material to exit the repository through the aperture and to be received by the platform; and
during movement of the ram from the home position to the pushing position, the ram transfers the material from the platform into the rotating trommel.

2. The apparatus of claim 1, further comprising an actuator configured to drive the ram cyclically from the home position to the pushing position.

3. The apparatus of claim 2, wherein the actuator is further configured to rotate the trommel.

4. The apparatus of claim 2, wherein:
the hopper further includes a door configured to cyclically move from an open position to a closed position;
in the closed position, the door retards the material on the platform from entering the trommel; and
in the open position, the door allows the material on the platform to enter the trommel.

5. The apparatus of claim 4, wherein the ram is mechanically linked to the door, such that movement of the door from the closed position to the open position transitions the ram from the home position to the pushing position.

6. The apparatus of claim 5, wherein the ram is mechanically linked to the door via a bell crank.

7. The apparatus of claim 4, wherein the actuator is further configured to cyclically move the door from the open position to the closed position.

8. The apparatus of claim 7, wherein:
the hopper includes a cam mechanically linked to the trommel, such that rotation of the trommel rotates the cam;
the cam has an eccentric perimeter with a base radius and a prime radius that is larger than the base radius; and
the cam is configured to engage with the door, such that:
the door is in the closed position when the perimeter of the cam with the base radius engages with the door; and
the door is in the open position when the perimeter of the cam with the prime radius engages with the door.

9. The apparatus of claim 2, further comprising the trommel and a trommel actuator configured to rotate the trommel, wherein the trommel actuator is separate and distinct from the actuator configured to drive the ram.

10. A method for sorting agricultural material stored in a hopper using a ram and a trommel, the method comprising:
placing the agricultural product in the hopper, such that the agricultural product is stored in a repository of the hopper;
positioning the ram in a home position, such that a portion of the agricultural product exits the repository by passing through an aperture of the hopper onto a platform of the hopper;
moving the ram from the home position to a pushing position, such that the ram transfers the material from the platform into the trommel; and
cyclically driving the ram across the platform from the home position to the pushing position, such that the agricultural product passes through the aperture of the hopper onto the platform and is transferred from the platform to the trommel.

11. The method of claim 10, wherein the cyclical driving of the ram across the platform is performed using an actuator.

12. The method of claim 11, further comprising rotating the trommel using the actuator to screen the agricultural material based on size and shape.

13. The method of claim 11, further comprising cyclically moving a door of the hopper from an open position to a closed position;
wherein in the closed position, the door retards the material on the platform from entering the trommel; and
wherein in the open position, the door allows the material on the platform to enter the trommel.

14. The method of claim 13, wherein the cyclical movement of the door from the open position to the closed position is performed using the actuator.

15. The method of claim 11, further comprising rotating the trommel using a trommel actuator that is separate and distinct from the actuator used to drive the ram.

16. The method of claim 10, wherein the agricultural material is from a cannabaceae plant.

17. An apparatus for sorting material from cannabaceae plants comprising:
a hopper having a repository configured to receive and store the material, an aperture comprising an opening in the repository and providing an exit from the repository for the material stored in the repository, and a platform configured to receive the material exiting the repository through the aperture;
a trommel configured to receive the material from the hopper and screen the material based on size and shape; and
a ram configured to cyclically move across the platform from a home position to a pushing position, wherein:
in the home position, the ram is positioned to allow the material to exit the repository through the aperture and to be received by the platform;
during movement of the ram from the home position to the pushing position, the ram transfers the material from the platform into the trommel.

18. The apparatus of claim 17, further comprising an actuator configured both to drive the ram cyclically from the home position to the pushing position and to rotate the trommel.

19. The apparatus of claim 17, wherein:
the hopper further includes a door configured to cyclically move from an open position to a closed position;
in the closed position, the door retards the material on the platform from entering the trommel;
in the open position, the door allows the material on the platform to enter the trommel; and
the ram is mechanically linked to the door, such that movement of the door from the closed position to the open position transitions the ram from the home position to the pushing position.

20. The apparatus of claim 19, wherein:
the hopper includes a cam mechanically linked to the trommel, such that rotation of the trommel rotates the cam;
the cam has an eccentric perimeter with a base radius and a prime radius that is larger than the base radius; and
the cam is configured to engage with the door, such that:
the door is in the closed position when the perimeter of the cam with the base radius engages with the door; and
the door is in the open position when the perimeter of the cam with the prime radius engages with the door.
